(19) United States
(12) Patent Application Publication
(10) Pub. No.: US 2013/0187066 A1
(43) Pub. Date: Jul. 25, 2013

(54) Infrared emitter

(71) Applicants: Hans-Willi Heller, Wipperfuerth (DE); Reinhold Meier, Wipperfuerth (DE); Markus Roth, Bonn (DE)

(72) Inventors: Hans-Willi Heller, Wipperfuerth (DE); Reinhold Meier, Wipperfuerth (DE); Markus Roth, Bonn (DE)

(73) Assignee: OSRAM AG, Muenchen (DE)

(21) Appl. No.: 13/812,545

(22) PCT Filed: Sep. 19, 2011
(86) PCT No.: PCT/EP11/66210

§ 371 Date: Jan. 28, 2013

(30) Foreign Application Priority Data
Oct. 11, 2010 (DE) 10 2010 042 283.5

(51) Int. Cl. H01J 61/30

(52) U.S. Cl. CPC H01J 61/30
USPC 250/504 R

(57) ABSTRACT

A single-ended infrared emitter may be provided, having at least one glass tube, in which a heating element is accommodated, wherein at least one insulated current return line is arranged spaced apart from the glass tube.

### TECHNICAL FIELD

The invention is based on single-ended infrared emitters or halogen infrared emitters. Infrared emitters have an emitter vessel, which surrounds a heating element. Halogen infrared emitters are infrared emitters with an emitter vessel which additionally surrounds a halogen-containing fill in order to maintain a halogen cycle process during operation.

### PRIOR ART

In the case of single-ended infrared emitters, designs are known which have linear integrally manufactured double tubes consisting of quartz glass, the cross section of said double tubes being similar to the shape of an 8. The term single-ended means that an electrical external contact for the connection to an electrical power supply is provided only on one side of the infrared emitter. The web site www.heraeus-noblelight.com owned by the company Heraeus Noble light discloses such halogen infrared emitters with a base having respective light-emitting or heating elements in the two tubes, wherein an electrical connection between the two tubes is provided at one end of the double tube, while a base with the corresponding connection contacts for a holder is provided at the other end of the double tube. In this case, different variants with heating elements in both tubes are disclosed. One disadvantage with such halogen infrared emitters is the electrical series connection of the two heating elements, which has the result that it is only possible for the two heating elements to be operated together.

Furthermore, variants of halogen infrared emitters are known in which a heating element is arranged only in one of the two tubes, while a current return line is provided in the other tube. One disadvantage with such halogen infrared emitters is the low degree of flexibility in terms of the arrangement of the current return line which results from the prefabricated double tube.

### DESCRIPTION OF THE INVENTION

The object of the present invention consists in providing a single-ended infrared emitter which provides improved flexibility in terms of the arrangement of the current return line.

This object is achieved by an infrared emitter having the features of patent claim 1.

Particularly advantageous configurations are given in the dependent claims.

The single-ended infrared emitter according to the invention has at least one glass tube, preferably consisting of quartz glass, in which a heating element is accommodated, wherein at least one insulated current return line is arranged spaced apart from the glass tube. In particular as a result of the thus freely selectable distance between the current return line and the glass tube, a flexible arrangement of the current return line is made possible.

A particularly preferred development of the infrared emitter has a base, which is fastened to a first end section of the glass tube, in particular using cement, and which can be suitable for being accommodated in a holder or can be connected to cables. A connecting element is fastened, likewise in particular using cement, to a second end section of the glass tube, with the connecting element being used to conductively connect the heating element to the current return line. In this case, it is preferred if the base and the connecting element consist of ceramic.

In a particularly preferred development, the current return line is formed by an electrical conductor, which is arranged in an insulating tube, wherein this insulating tube preferably runs parallel to the glass tube. Thus, this development of the infrared emitter is particularly suitable for use in a process chamber, in which protection against touching contact and against aggressive environmental media (for example paints) is required. The cross section of the insulating tube may be smaller than the cross section of the glass tube.

It is preferred if the insulating tube consists substantially of quartz or ceramic, wherein the conductor arranged therein is liquid or solid.

In this case, it is preferred if the conductor consists of wire, which has at least one turn at one end section. Thus, simple and efficient compensation of thermal expansion of the wire is made possible.

A particularly preferred development of the infrared emitter according to the invention has a reflector for aligning or focusing the thermal radiation (infrared radiation). In this case, optimum flexibility of the arrangement and shape of the reflector on the infrared emitter according to the invention is provided.

In a particularly preferred application, the reflector is arranged, at least sectionally, between the glass tube and the current return line. Thus, the thermal loading of the current return line is minimized.

The reflector can consist at least partially of gold or aluminum or quartz or ceramic or silica.

In a first variant, the reflector is fastened to the base and/or to the connecting element. For this purpose, notches in the base or in the connecting element can be used, with the reflector (for example with projections) being inserted into said notches.

In a second variant, the reflector is fastened to the glass tube, preferably by being immersed or sprayed or baked or adhesively bonded.

The base or the connecting element can correspond to the type GX9.5, G12, G16, G22, G38, E27 or E40.

The heating element can be an incandescent filament, in particular consisting of tungsten or other high-melting material compounds such as tantalum carbide, or a strip-shaped heater, in particular consisting of carbon.

In a preferred development, the first and second end sections of the glass tube have approximately the same configuration and are fastened approximately identically to the connecting element or to the base. It is thus possible to use a lamp or an emitter which is provided or can at least be used for a two-ended base application.

### BRIEF DESCRIPTION OF THE DRAWINGS

The invention will be explained in more detail below with reference to exemplary embodiments. In the figures:

FIG. 1 shows a first exemplary embodiment of a halogen infrared emitter according to the invention in a side view;

FIG. 2 shows a second exemplary embodiment of a halogen infrared emitter according to the invention in a sectional illustration;

FIG. 3 shows a third exemplary embodiment of a halogen infrared emitter according to the invention in a sectional illustration;

FIG. 4 shows a fourth exemplary embodiment of a halogen infrared emitter according to the invention in a sectional illustration;

FIG. 5 shows a fifth exemplary embodiment of a halogen infrared emitter in a sectional illustration; and

FIG. 6 shows a sixth exemplary embodiment of a halogen infrared emitter according to the invention in a sectional illustration.

### PREFERRED EMBODIMENT OF THE INVENTION

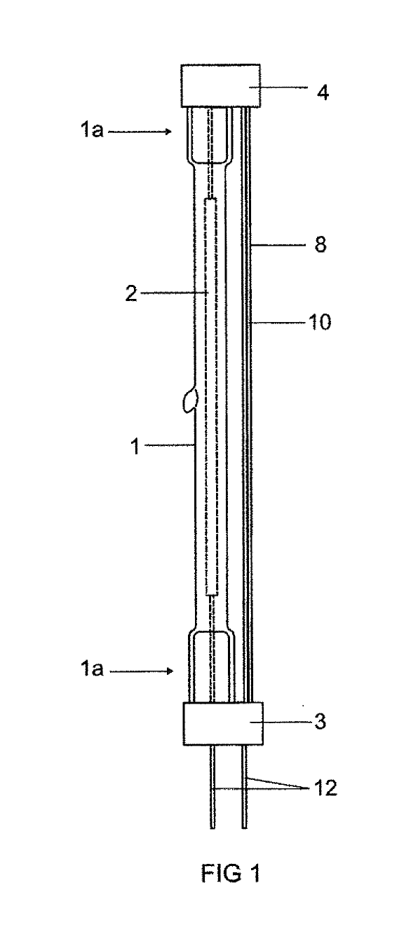

FIG. 1 shows a first exemplary embodiment of a halogen infrared emitter according to the invention in a side view. It has a quartz glass tube 1, in which an incandescent filament 2 is arranged concentrically.

The quartz glass tube 1 has a pinch seal 1a at each of its two end sections, wherein the lower (in FIG. 1) pinch seal 1a has been inserted into a base 3 consisting of ceramic, while the upper (in FIG. 1) pinch seal 1a has been inserted into a connecting element 4 consisting of ceramic.

A current return line is provided parallel to the quartz glass tube 1, extends approximately parallel to the quartz glass tube 1 and is fastened to the base 3 and to the connecting element 4. The current return line has an electrically conductive wire 10, which is accommodated in an insulating tube 8 consisting of quartz or ceramic.

Two electrically conductive cables 12 are fastened on one side of the base 3, said side being remote from the quartz glass tube 1 and the insulating tube 8, the right-hand (in figure) cable 12 of said cables being connected via the wire 10 to an upper (in FIG. 1) end section of the incandescent filament 2.

The insulating tube 8 is inserted into the base 3 and into the connecting element 4 and is cemented fixedly there. The lower part of the base 3 is filled with sand (not shown), with the result that a weld point of the wire 10 and the corresponding end section of the insulating tube 8 are enveloped by sand. An upper (in FIG. 1) part of the base 3 is sealed with cement.

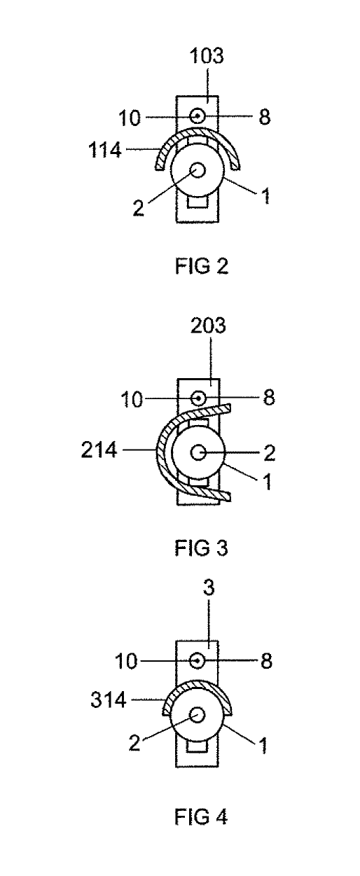

FIG. 2 shows a second exemplary embodiment of a halogen infrared emitter according to the invention in a sectional illustration. In this case, the filament 2, the quartz glass tube 1, the wire 10 and the insulating tube 8 are designed in accordance with the first exemplary embodiment (cf. FIG. 1) and are cut transversely to a lamp longitudinal axis in FIG. 2.

In this case, a gap between the wire 10 with the insulating tube 8, on the one hand, and the incandescent filament 2 with the quartz glass tube 1, on the other hand, is enlarged with respect to the first exemplary embodiment. Correspondingly, a base 103 and a connecting element (not shown in FIG. 2) are enlarged.

A metal reflector 114 provided with a suitable shape in cross section (for example spherical, parabolic, elliptical, etc.) is arranged in the thus enlarged gap. Said reflector extends from the base 103 up to the connecting element and reflects the thermal radiation (infrared radiation) (in FIG. 2) which is emitted upwards from the incandescent filament 2 over its entire length (in FIG. 2) downwards. Thus, focusing of the thermal radiation of the second exemplary embodiment of the halogen infrared emitter according to the invention is provided.

The reflector 114 is fastened at its two end sections firstly to the base 103 and secondly to the connecting element. This fastening can take place by respective projections on the reflector 114 which dip into corresponding depressions in the base 103 and the connecting element.

By virtue of the arrangement shown, the current return line consisting of wire 10 and insulating tube 8 is protected against thermal loading in optimum fashion.

FIG. 3 shows a third exemplary embodiment of a halogen infrared emitter according to the invention in a sectional illustration. The third exemplary embodiment has a reflector 214, whose cross section and reflection character are changed with respect to the second exemplary embodiment shown in FIG. 2.

The fastening of the reflector 214 to a base 203 and to a connecting element (not shown in FIG. 3) is performed in each case on both sides of the quartz glass tube 1.

In the third exemplary embodiment as well, in which the wire 10 with the insulating tube 8 is arranged laterally with respect to the emission direction of the halogen infrared emitter, the power return line 8, 10 is protected against thermal loading since the reflector 214 extends into the gap between the insulating tube 8 and the quartz glass tube 1.

FIG. 4 shows a fourth exemplary embodiment of a halogen infrared emitter according to the invention in a sectional illustration. The essential difference between the fourth exemplary embodiment and the second and third exemplary embodiments consists in that a reflector 314 is provided which is applied directly to the quartz glass tube 1 (for example by means of immersion, spraying, baking or adhesive bonding). The base 3 and the connecting element correspond to those in the first exemplary embodiment shown in FIG. 1.

The reflector 314 is applied to the quartz glass tube 1 before said quartz glass tube is inserted between the base 3 and the connecting element 4.

FIG. 5 shows a fifth exemplary embodiment of a halogen infrared emitter according to the invention in a cross section. In this case, in contrast to the first exemplary embodiment shown in FIG. 1, an enlarged base 403 and a corresponding enlarged connecting element (not shown) are provided. Furthermore, as a deviation from the incandescent filament 2 from the first exemplary embodiment, a strip-shaped heater 402 consisting of carbon is arranged in the quartz glass tube 1.

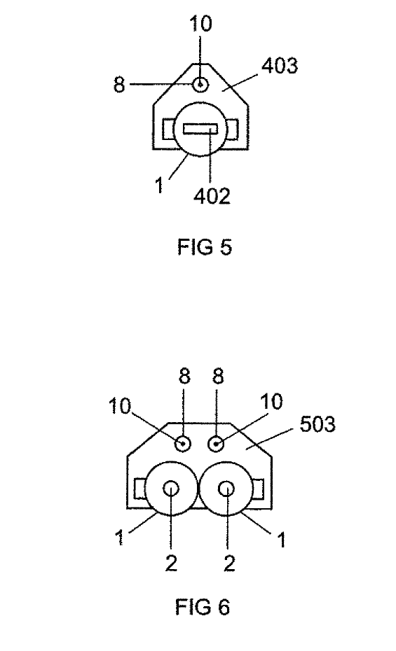

FIG. 6 shows a sixth exemplary embodiment of a halogen infrared emitter according to the invention in cross section. In this case, two incandescent filaments 2 and two quartz glass tubes 1 in accordance with the first exemplary embodiment are arranged directly next to one another, with the two quartz glass tubes 1 touching one another along the lamp longitudinal axis. Correspondingly, a markedly enlarged base 503 and a corresponding connecting element (not shown) are provided in relation to the first exemplary embodiment. Two current return lines which each consist of a wire 10 and an insulating tube 8 in accordance with the first exemplary embodiment are passed between said base and said connecting element.

This opens up the possibility of varying the power of the sixth exemplary embodiment over a wide range by means of connecting or disconnecting or dimming one or both incandescent filaments 2.

As a deviation from the above-described exemplary embodiment with sand, the base 3 can also be completely cemented. In this case, the wire 10 has at least one turn or filament which can compensate for a thermal expansion of the wire 10.

1. A single-ended infrared emitter comprising at least one glass tube, in which a heating element is accommodated, wherein at least one insulated current return line is arranged spaced apart from the glass tube.

2. The infrared emitter as claimed in claim 1, comprising a base fastened to a first end section of the glass tube, and comprising a connecting element which is fastened to a second end section of the glass tube and via which the heating element is conductively connected to the current return line.

3. The infrared emitter as claimed in claim 1, wherein the current return line comprises an insulating tube and a conductor which is arranged in the insulating tube.

4. The infrared emitter as claimed in claim 3, wherein a cross section of the insulating tube is smaller than a cross section of the glass tube.

5. The infrared emitter as claimed in claim 3, wherein the insulating tube consists substantially of quartz or ceramic, or wherein the conductor is liquid or solid.

6. The infrared emitter as claimed in claim 3, wherein the conductor consists of wire which comprises at least one turn at an end section.

7. The infrared emitter as claimed in claim 1, further comprising a reflector.

8. The infrared emitter as claimed in claim 7, wherein the reflector is arranged, at least sectionally, between the glass tube and the current return line.

9. The infrared emitter as claimed in claim 7, wherein the reflector consists at least partially of gold or aluminum or quartz or ceramic or silica.

10. The infrared emitter as claimed in claim 2, further comprising a reflector, wherein the reflector is fastened to at least one of the base (103; 203) and the connecting element.

11. The infrared emitter as claimed in claim 7, wherein the reflector is arranged or fitted on the glass tube.

12. The infrared emitter as claimed in claim 2, wherein the base or the connecting element corresponds to the type GX9.5, G12, G16, G22, G38, E27 or E40.

13. The infrared emitter as claimed in claim 1, wherein the heating element is an incandescent filament or a strip-shaped heater.

14. The infrared emitter as claimed in claim 2, wherein the first and second end sections of the glass tube have an identical configuration and are fastened identically to the connecting element or the base.

15. The infrared emitter as claimed in claim 1, configured as a halogen infrared emitter.

16. The infrared emitter as claimed in claim 3, wherein the insulating tube consists substantially of quartz or ceramic, and wherein the conductor is liquid or solid.
